(19) United States
(12) Patent Application Publication
(10) Pub. No.: US 2025/0360755 A1
(43) Pub. Date: Nov. 27, 2025

(54) VEHICULAR WHEEL BEARING

(71) Applicant: ILJIN GLOBAL CO., LTD., Seoul (KR)

(72) Inventors: Dongho GEUM, Seoul (KR); Junho LEE, Seoul (KR)

(73) Assignee: ILJIN GLOBAL CO., LTD., Seoul (KR)

(21) Appl. No.: 19/219,010

(22) Filed: May 27, 2025

(30) Foreign Application Priority Data
May 27, 2024 (KR) 10-2024-0068352

(51) Int. Cl. B60B 27/00; B60B 27/02; F16D 1/10

(52) U.S. Cl. CPC B60B 27/0078; B60B 27/02; F16D 1/10; B60B 2310/226; F16D 2001/103

(57) ABSTRACT

A vehicular wheel bearing includes: a wheel hub having a bent portion formed by bending a vehicle-body side end in a radially outward direction; at least one inner ring coupled on an outer peripheral surface of the wheel hub; an outer ring provided to be spaced apart from the wheel hub and the at least one inner ring in the radially outward direction; rolling bodies provided between the wheel hub and the outer ring; and a coupler ring disposed between the inner ring and the bent portion. The coupler ring includes an inner coupler-ring spline portion, and a ring-shaped inner protrusion portion. A first interference magnitude between the inner protrusion portion and the wheel hub may be set to be greater than zero such that the inner protrusion portion and the wheel hub are coupled to each other in a loosely fitting manner.

### CROSS-REFERENCE TO RELATED APPLICATIONS

This application claims priority to Korean Patent Application No. 10-2024-0068352 filed on May 27, 2024, the entire contents of which are herein incorporated by reference.

### TECHNICAL FIELD

The present disclosure relates to a vehicular wheel bearing, and more particularly to a vehicular wheel bearing, which is applied to a part-time-type four-wheel-drive vehicle, which enables stable power transmission by minimizing deformation of a coupler due to orbital forming (plastic deformation).

### BACKGROUND

As a four-wheel-drive vehicle, a full-time-type four-wheel-drive vehicle and a part-time-type four-wheel-drive vehicle have been known. Among these, the part-time-type four-wheel-drive vehicle is a vehicle which is capable of being changed between a two-wheel-drive state and a four-wheel-drive state. For example, a driven wheel may be separated from a vehicle shaft of a driving system such that the driven wheel is in a free state and does not rotate relative to a vehicle body. Further, the driven wheel may be connected to the vehicle shaft of the driving system such that the driven wheel is in a lock state and receives a driving power from an engine. The separation and connection of the driven wheel from and to the vehicle body may be implemented by a coupler ring and a gear ring.

FIG. 1 is a diagram illustrating an orbital forming process performed on a wheel bearing in the related art. A coupler ring 1 has a spline portion formed on each of an inner peripheral surface and an outer peripheral surface. The spline portion formed on the inner peripheral surface of the coupler ring 1 is fitted into a spline portion formed on an outer peripheral surface of a wheel hub. A vehicle-body-side end portion is bent (for example, orbital-formed) to finally fix an inner ring 2 and the coupler ring 1 to each other. A gear ring (not illustrated) of a clutch is slidable in an axial direction on an outer peripheral surface of the coupler ring 1 thus finally fixed. As the gear ring slides toward the wheel, a spline portion formed on an outer peripheral surface of the gear ring is fitted into the spline portion formed on the outer peripheral surface of the coupler ring 1 so that a rotational driving force from the clutch is transmitted to the wheel hub via the coupler ring 1. In contrast, when the gear ring slides toward the vehicle body, the gear ring and the coupler ring 1 are separated from each other so that the rotational drive force from the clutch is not transmitted to the coupler ring 1.

Meanwhile, in a structure of the wheel bearing in the related art, when a vehicle-body-side end portion of the wheel hub is bent to form a bent portion 3 (as illustrated in FIG. 1), a remarkable amount of load may be applied to the coupler ring 1, which causes deformation of the coupler ring 1.

Since the coupler ring 1 has the spline portion formed on the outer peripheral surface thereof to be coupled to the spline portion of the gear ring, it requires a certain level or more of accuracy. Thus, due to the deformation of the coupler ring 1, defects may occur in the coupling between the spline portions. This is not desirable for power transmission.

As illustrated in FIG. 1, in order to solve matters such as the deformation of the coupler ring in the related art, a technique for fixing the outer peripheral surface of the coupler ring 1 with a separate equipment (for example, a fixing jig 4) during the orbital forming process has been proposed. However, the separate equipment needs to be provided and the orbital forming process becomes complicated. In addition, the fixing jig 4 needs to have a spline formed to be engaged with the outer peripheral surface of the coupler ring. This makes a manufacturing process difficult. Further, it is unclear whether the fixing jig 4 prevents a minute deformation of several microns from being generated at the outer peripheral surface of the coupler ring.

### PRIOR ART DOCUMENT

### [Patent Document]

Patent Document 1: Japanese Laid-Open Patent Publication No. 2013-024393 (published on Feb. 4, 2013)

### SUMMARY

The present disclosure was made to solve the above-mentioned matters, and the present disclosure is for the purpose of providing a vehicular wheel bearing, which enables stable power transmission by minimizing deformation of a coupler during an orbital forming.

According to an example embodiment of the present disclosure, a vehicular wheel bearing may include: a wheel hub 100 having a bent portion 130 formed by bending an end of a vehicle-body side in a radially outward direction; at least one inner ring 300 coupled on an outer peripheral surface of the wheel hub 100; an outer ring 200 provided to be spaced apart by a certain interval from the wheel hub 100 and the at least one inner ring 300 in the radially outward direction; rolling bodies 500 provided between the wheel hub 100 to which the at least one inner ring 300 is coupled and the outer ring 200; and a coupler ring 400 disposed between the inner ring 300 and the bent portion 130. The coupler ring 400 may include an inner coupler-ring spline portion 420, which is coupled to an outer wheel-hub spline portion 152 formed on the outer peripheral surface of the wheel hub 100, and a ring-shaped inner protrusion portion 440 having no spline, which is protruded in a radially inward direction, the inner coupler-ring spline portion 420 and the ring-shaped inner protrusion portion 440 being formed on an inner peripheral surface of the coupler ring 400. A first interference magnitude A between the inner protrusion portion 440 and the wheel hub 100 may be set to be greater than zero such that the inner protrusion portion 440 and the wheel hub 100 are coupled to each other in a loosely fitting manner.

In an aspect, the inner coupler-ring spline portion 420 may be coupled to the outer wheel-hub spline portion 152 in a press-fitting manner, and the coupling of the inner coupler-ring spline portion 420 and the outer wheel-hub spline portion 152 in the press-fitting manner may be implemented by press-fitting generated between a tooth side surface of the inner coupler-ring spline portion 420 and a tooth side surface of the outer wheel-hub spline portion 152.

In an aspect, a second interference magnitude B between the inner coupler-ring spline portion 420 and the outer wheel-hub spline portion 152 may be set to be greater than zero.

In an aspect, a third interference magnitude C between the inner coupler-ring spline portion 420 and the outer wheel-hub spline portion 152 may be set to be greater than zero.

In an aspect, a first interference magnitude A between the inner protrusion portion 440 and the wheel hub 100 may be in a range of 2 to 7 micrometer (μm).

In an aspect, the wheel hub 100 may have a first outer peripheral surface 150 on which the outer wheel-hub spline portion 152 is formed, a second outer peripheral surface 160 which extends obliquely from an end of the vehicle-body side to a wheel-side of the first outer peripheral surface 150 in the radially inward direction, and a third outer peripheral surface 170 which extends from an end of the vehicle-body side to the wheel side of the second outer peripheral surface 160. The first interference magnitude A may be formed between the inner protrusion portion 440 and the third outer peripheral surface 170 of the wheel hub 100. The second interference magnitude B may be formed between the inner coupler-ring spline portion 420 and the first outer peripheral surface 150 of the wheel hub 100.

In an aspect, wherein a height h3 of the inner protrusion portion 440 may be set to be greater than a height h4 of a tooth-shaped portion of the inner coupler-ring spline portion 420.

In an aspect, an inner peripheral surface 442 of the inner protrusion portion 440 may be disposed radially inward of the first outer peripheral surface 150 of the wheel hub 100.

In an aspect, a maximum thickness T1 of an area in which the inner protrusion portion 440 of the coupler ring 400 is formed may fall within a range of 1.2 to 1.8 times a minimum thickness T2 of an area in which the inner coupler-ring spline portion 420 of the coupler ring 400 is formed.

In an aspect, the inner peripheral surface of the coupler ring 400 may be formed by cutting out a portion corresponding to a tooth-shaped groove of the inner coupler-ring spline portion 420 in a ring-shaped structure having a first inner diameter D3 and a second inner diameter D4 smaller than the first inner diameter D3. Wheel bearings for vehicles.

According to a vehicular wheel bearing of the present disclosure, by setting individual constituent elements of a coupler ring in different fitting manners, it is possible to minimize deformation of the coupler ring during an orbital forming and implement a stable power transmission.

Further, according to a coupling structure of the coupler ring and a wheel hub of the vehicular wheel bearing of the present disclosure, it is possible to more easily implement a configuration in which first and second interference amounts are differently set (in the unit of several microns), and reinforce the rigidity of a portion (inner protrusion portion) of the coupler ring, which may be affected during the orbital forming, thus further preventing the coupler ring from being deformed.

### BRIEF DESCRIPTION OF THE DRAWINGS

FIG. 1 is a diagram for explaining an orbital forming process performed on a wheel bearing in the related art.

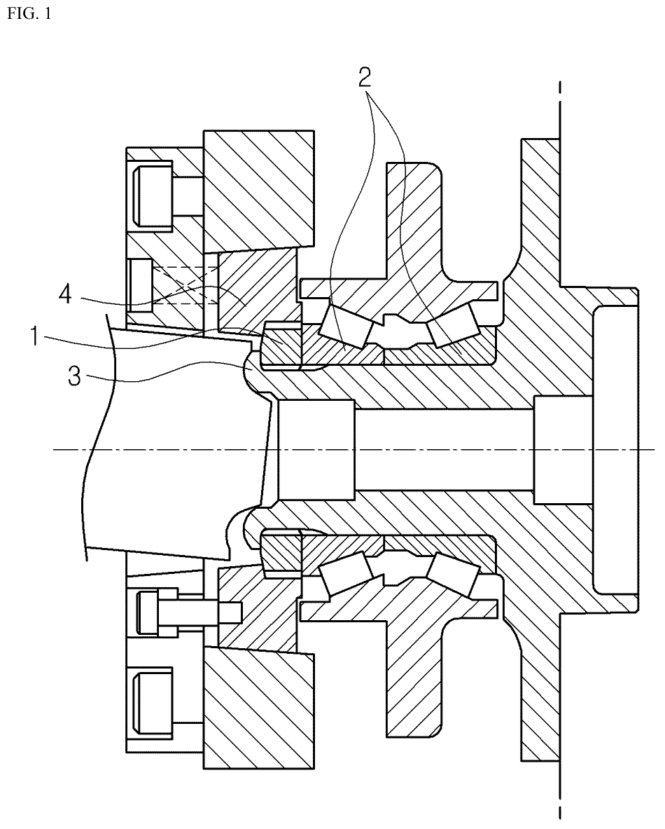

FIG. 2 is a cross-sectional view of a vehicular wheel bearing according to an example embodiment of the present disclosure.

FIG. 3 is an enlarged cross-sectional view of the wheel bearing according to an example embodiment of the present disclosure.

FIG. 4 is an enlarged cross-sectional view for explaining a state in which an inner coupler-ring spline portion and an outer wheel-hub spline portion are coupled to each other according to an example embodiment of the present disclosure.

### DETAILED DESCRIPTION

Hereinafter, preferred example embodiments of the present disclosure will be described in detail with reference to the accompanying drawings.

In order to clearly describe the present disclosure, detailed descriptions of parts irrelevant to the present disclosure will be omitted, and the same reference numerals will be given to the same constituent elements throughout the specification. Further, a shape and size of each constituent element illustrated in the drawings are arbitrarily illustrated for the sake of convenience in description, and hence the present disclosure is not necessarily limited to the shape and size illustrated. That is, it is to be understood that specific shapes, structures, and characteristics described herein may be modified from an example embodiment to another embodiment without departing from the spirit and scope of the present disclosure. Positions or arrangements of individual constituent elements may also be modified without departing from the spirit and scope of the present disclosure.

Therefore, the detailed description described below is not to be taken in a limiting sense, and the scope of the present disclosure is to be taken as covering the scope claimed by the appended claims and their equivalents.

When a part “comprises or includes” a constituent element through the specification, this means that the part may further include other constituent elements, rather than excluding other constituent elements, unless other stated.

Throughout the specification, in all constituent elements constituting a wheel bearing, a direction toward a wheel with reference to an extension direction of a rotational axis of a wheel hub is referred to as a “wheel side,” and a direction opposite the direction toward the wheel is referred to as a “vehicle-body side.”

Further, in all the constituent elements constituting the wheel bearing, a direction toward the rotational axis with reference to a direction perpendicular to the rotational axis of the wheel hub is referred to as a “radially inward direction”, and a direction opposite the direction toward the rotational axis is referred to as a “radially outward direction”.

Parts denoted by the same reference numerals throughout the specification refer to the same or similar constituent elements.

Hereinafter, an overall structure of a vehicular wheel bearing will be first described, and a coupling structure of a coupler ring and a wheel hub will be sequentially described in more detail.

### 1. Overall Structure of Vehicular Wheel Bearing

Hereinafter, preferred example embodiments of the present disclosure will be described in more detail with reference to the accompanying drawings.

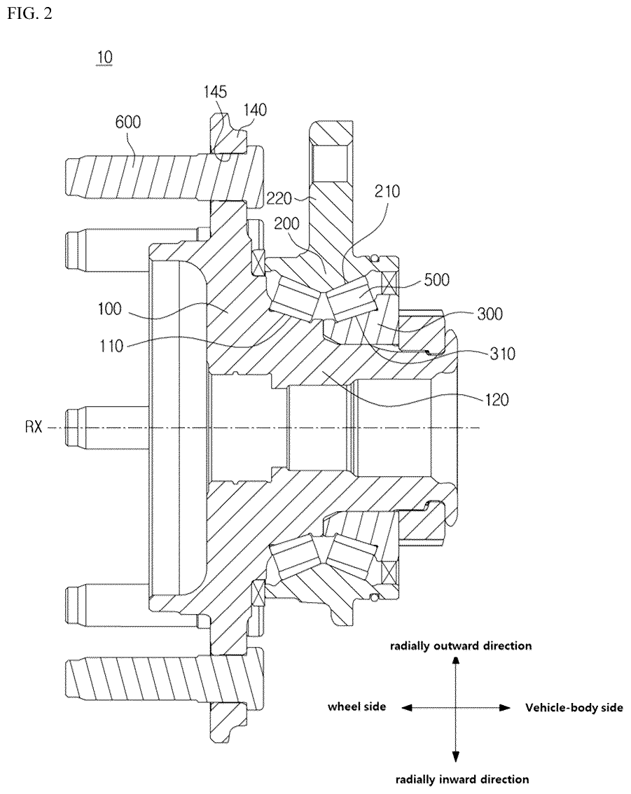

FIG. 2 is a cross-sectional view of a vehicular wheel bearing according to an example embodiment of the present disclosure. For the sake of convenience in description, the wheel bearing illustrated in FIG. 2 is merely one of various kinds of wheel bearings, and the technical ideas of the present disclosure may be applied to various kinds of wheel bearings without being limited to the wheel bearings illustrated herein.

Referring to FIG. 2, a vehicular wheel bearing 10 according to an example embodiment of the present disclosure may be used for a wheel bearing of a part-time-type four-wheel-drive vehicle.

The vehicular wheel bearing 10 may include a wheel hub 100, at least one inner ring 300 coupled to an outer peripheral surface of the wheel hub 100, an outer ring 200 provided to be spaced apart by a certain distance from the wheel hub 100 and the at least one inner ring 300 in the radially outward direction, and rolling bodies 500 provided between the wheel hub 100 to which the at least one inner ring 300 is coupled and the outer ring 200.

While one inner ring 300 has been illustrated to be mounted on the wheel hub 100 in FIG. 2, the wheel bearing 10 of the present disclosure is not limited to such a structure. It should be understood that two or more (for example, a pair of) inner rings may be mounted on the wheel hub 100. In addition, in this specification, the expression “the rolling bodies are provided between the wheel hub 100 to which at least one inner ring 300 is coupled and the outer ring 200” should be understood as encompassing not only a configuration in which one inner ring is applied to the wheel hub, but also a configuration in which multiple inner rings are applied to the wheel hub, as illustrated in FIG. 2. That is, in FIG. 2, wheel-side rolling bodies (in other words, rolling bodies at an outboard side) are illustrated to be mounted between the wheel hub and the outer ring, and vehicle-body-side rolling bodies (in other words, rolling bodies at an inboard side) are illustrated to be mounted between the inner ring and the outer ring. However, in a case in which a pair of inner rings is applied, the wheel-side rolling bodies and the vehicle-body-side rolling bodies may be provided between the pair of inner rings and the outer ring. In this specification, the expression “the rolling bodies are provided between the wheel hub to which at least one inner ring is coupled and the outer ring” should be understood as encompassing such an example. Hereinafter, an example in which one inner ring is applied will be described in detail with reference to FIG. 2.

The outer ring 200 is coupled to a vehicle body (for example, a knuckle (not illustrated)). The outer ring 200 includes a vehicle-body installation flange portion 220 protruding in the radially outward direction. The vehicle-body installation flange portion 220 of the outer ring 200 may be coupled to the knuckle via a knuckle bolt which penetrates in an axial direction.

According to an example embodiment of the present disclosure, the wheel hub 100 may have a cylindrical shape extending in the axial direction. At least one inner ring 300 is coupled to the outer peripheral surface of the wheel hub 100 in a press-fitting manner.

The wheel hub 100 may be connected to the wheel and is rotatable about an imaginary rotational axis RX parallel to the axial direction. The inner ring 300 may be formed in a ring shape and may be configured to surround at least a part of an outer peripheral surface of the wheel hub 100. The inner ring 300 is configured to rotate together with the wheel hub 100. The wheel hub 100 is coupled to the wheel. Thus, when the wheel hub 100 rotates about the imaginary rotational axis RX parallel to the axial direction with the rotation of the wheel, the inner ring 300 may also rotate together with the wheel hub 100 about the imaginary rotational axis RX.

For example, the wheel hub 100 may include a wheel installation flange 140 integrally formed to install the wheel (not illustrated) thereon at a wheel-side end portion. As illustrated in FIG. 2, wheel mounting bolts 600 may be inserted into wheel mounting openings 145 formed to extend in the axial direction and penetrate through the wheel installation flange 140 of the wheel hub 100, respectively. The wheel mounting bolts 600 may be arranged to be spaced apart from each other in a circumferential direction in a concentric relationship with the imaginary rotational axis RX. Thus, the wheel hub 100 may be coupled to the wheel with the wheel mounting bolts 600.

The wheel hub 100 and the inner ring 300 have inner raceway surface 110 and 310 tapered on outer peripheries thereof, respectively, and are press-fitted into each other at a certain interference magnitude by a small-diameter portion 120 of the wheel hub 100.

The wheel bearing 10 may be configured to include a plurality of rolling bodies 500 provided in, for example, multiple rows. As an example, the rolling bodies 500 may be tapered rollers. The present disclosure is not limited thereto. The rolling bodies 500 may be balls, barrel rollers, or the like.

The outer ring 200 may be configured to include a vehicle-body installation flange portion 220 formed integrally to mount a knuckle (not illustrated) on an outer periphery thereof. The knuckle constitutes a suspension device. The outer ring 200 has multiple rows of outer raceway surfaces 210 formed in a tapered shape on an inner periphery thereof, which are exposed outward.

The plurality of rolling bodies 500 are accommodated to be rollable between the inner raceway surface 110 of the wheel hub 100, the inner raceway surface 310 of the inner ring 300 and the outer raceway surface 210 of the outer ring 200. By the rolling bodies 500, the inner ring 300 may rotate relative to the outer ring 200.

### 2. Coupling Structure of Coupler Ring and Wheel Hub

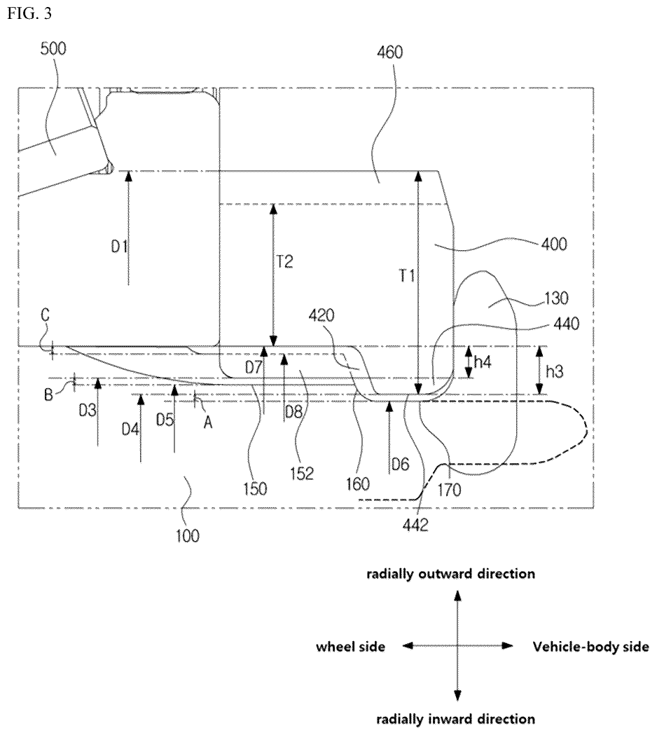

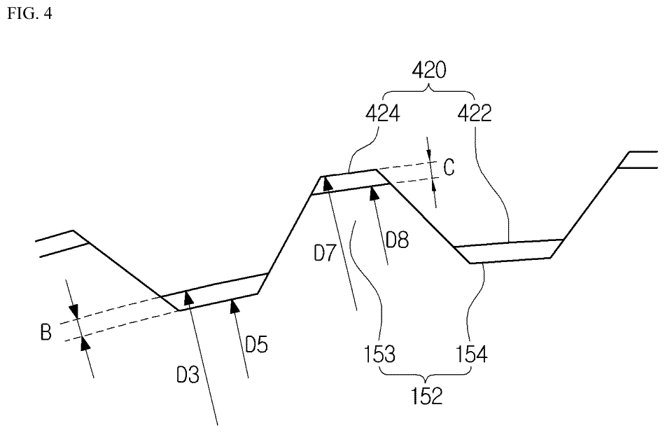

FIG. 3 is an enlarged cross-sectional view of a wheel bearing according to an example embodiment of the present disclosure. FIG. 4 is an enlarged cross-sectional view for explaining a state in which an inner coupler-ring spline portion and an outer wheel-hub spline portion are coupled to each other according to an example embodiment of the present disclosure.

Referring to FIGS. 3 and 4, before the orbital forming process, that is, before forming the bent portion 130, the outer ring 200, the inner ring 300, and the coupler ring 400 are sequentially coupled to the wheel hub 100 in a press-fitting manner from the wheel side. Thereafter, a vehicle-body-side end portion of the wheel hub 100 is bent (orbital-formed) in the radially outward direction to form the bent portion 130.

When viewed from the wheel side, the outer periphery of the wheel hub 100 may have a first outer peripheral surface 150 on which an outer wheel-hub spline portion 152 is formed, a second outer peripheral surface 160 formed to extend obliquely in the radially inward direction from a vehicle-body-side end of the first outer peripheral surface 150 toward the wheel, and a third outer peripheral surface 170 formed to extend from the vehicle-body-side end of the second outer peripheral surface 160 toward the wheel. The outer wheel-hub spline portion 152 is formed in a spline structure in which tooth-shaped portions 153 and tooth-shaped grooves 154 are alternately arranged.

The coupler ring 400 includes, on an inner peripheral surface thereof, an inner coupler-ring spline portion 420 and a ring-shaped inner protrusion portion 440 having no spline, which protrudes in the radially inward direction. The inner protrusion portion 440 has an inner peripheral surface 442 facing the third outer peripheral surface 170 of the wheel hub 100.

Further, the coupler ring 400 includes an outer coupler-ring spline portion 460 formed on an outer peripheral surface thereof to be engaged with a ring gear.

As an example, structures of the inner peripheral surface and the outer peripheral surface of the coupler ring 400 may be implemented by cutting portions corresponding to the tooth-shaped grooves of the inner and outer spline portions in a ring-shaped structure having an outer diameter D1, a first inner diameter D3 and a second inner diameter D4 (smaller than the first inner diameter D3) and forming the spline portions.

According to an example embodiment of the present disclosure, individual constituent elements of the coupler ring 400 may be provided in different coupling manners. That is, the inner coupler-ring spline portion 420 and the outer wheel-hub spline portion 152 may be coupled to each other in a forcibly fitting manner (that is, in a press-fitting manner), and the inner protrusion portion 440 (where no spline is formed) and the wheel hub 100 may be coupled to each other in a loosely fitting manner.

According to an example embodiment of the present disclosure, the coupling between the inner coupler-ring spline portion 420 and the outer wheel-hub spline portion 152 in the press-fitting manner may be implemented by press-fitting performed between a tooth side surface of the inner coupler-ring spline portion 420 and a tooth side surface of the outer wheel-hub spline portion 152.

In this specification, a first interference magnitude A between the inner protrusion portion 440 of the coupler ring 400 and the wheel hub 100 is defined as follows.

A=(inner diameter D4 of inner protrusion portion of coupler ring minus outer diameter D6 of third outer peripheral surface of wheel hub)/2

In this specification, a second interference magnitude B between the inner coupler-ring spline portion 420 and the outer wheel-hub spline portion 152 is defined as follows.

B=(inner diameter D3 of tooth-shaped portion of inner coupler-ring spline portion minus outer diameter D5 of tooth-shaped groove of outer wheel-hub spline portion)/2

In this specification, a third interference magnitude C between the inner coupler-ring spline portion 420 and the outer wheel-hub spline portion 152 is defined as follows.

C=(inner diameter D7 of tooth-shaped groove of inner coupler-ring spline portion minus outer diameter D8 of tooth-shaped portion of outer wheel-hub spline portion)/2)

According to an example embodiment of the disclosure, the inner coupler-ring spline portion 420 may be formed in a spline structure in which the tooth-shaped portions 422 and the tooth-shaped grooves 424 are arranged in an alternate manner, and the outer wheel-hub spline portion 152 may be formed in a spline structure in which the tooth-shaped portions 153 and the tooth-shaped grooves 154 are arranged in an alternate manner.

In the present disclosure, as described above, the first interference magnitude A between the inner protrusion portion 440 of the coupler ring 400 and the wheel hub 100 may be set to be larger than zero such that the inner coupler-ring spline portion 420 and the outer wheel-hub spline portion 152 are coupled to each other in a press-fitting manner (that is, in the forcibly fitting manner) and the deformation of the coupler ring 400 during the orbital forming process is reduced. As an example, preferably, the first interference magnitude A between the inner protrusion portion 440 of the coupler ring 400 and the wheel hub 100 may fall within a range of 2 to 7 μm. That is, the inner protrusion portion 440 of the coupler ring 400 is not press-fitted into the outer periphery of the wheel hub 100, and the inner protrusion portion 440 of the coupler ring 400 and the wheel hub 100 are fitted into each other in the loosely fitting manner. Thus, the fixation of the coupler ring 400 to the wheel hub 100 in the press-fitting manner may be implemented in the inner coupler-ring spline portion 420 and the outer wheel-hub spline portion 152. Further, during the orbital forming process, no crack may occur in the vicinity of the bent portion 130 and the deformation of the coupler ring 400 may be reduced.

According to an example embodiment of the present disclosure, in order to further reduce the deformation of the coupler ring 400 during the orbital forming process, the coupling between the inner coupler-ring spline portion 420 and the outer wheel-hub spline portion 152 in the press-fitting manner may be implemented between the tooth side surface of the inner coupler-ring spline portion 420 and the tooth side surface of the outer wheel-hub spline portion 152. In this case, both the second interference magnitude B between the inner coupler-ring spline portion 420 and the outer wheel-hub spline portion 152 and the third interference magnitude C between the inner coupler-ring spline portion 420 and the outer wheel-hub spline portion 152 may be set to be greater than zero.

Further, according to an example embodiment of the present disclosure, a height h3 of the inner protrusion portion 440 may be set to be greater than that of a tooth-shaped portion 422 of the inner coupler-ring spline portion 420. More preferably, the inner peripheral surface 442 of the inner protrusion portion 440 may be disposed radially inward of the first outer peripheral surface 150 of the wheel hub 100. As an example, the inner peripheral surface 442 of the inner protrusion portion 440 may be disposed radially inward of the first outer peripheral surface 150 of the wheel hub 100 by 3 to 12 μm or more.

Further, according to an example embodiment of the present disclosure, a maximum thickness T1 of an area where the inner protrusion portion 440 of the coupler ring 400 is formed may be set in a range of 1.2 to 1.8 times a minimum thickness T2 of an area where the inner coupler-ring spline portion 420 of the coupler ring 400 is formed.

Further, according to an example embodiment of the present disclosure, the outer periphery of the wheel hub 100 may have the first outer peripheral surface 150 on which the outer wheel-hub spline portion 152 is formed, the second outer peripheral surface 160 formed to extend obliquely in the radially inward direction from the vehicle-body-side end of the first outer peripheral surface 150 toward the wheel, and the third outer peripheral surface 170 formed to extend from the vehicle-body-side end of the second outer peripheral surface 160 toward the wheel. The first interference magnitude B is formed between the inner protrusion portion 440 of the coupler ring 400 and the third outer peripheral surface 170 of the wheel hub 100, and the second interference magnitude A is formed between the inner coupler-ring spline portion 420 and the outer wheel-hub spline portion (that is, the first outer peripheral surface 160).

According to the above-described structure, since the inner protrusion portion 440 of the coupler ring 400 and the inner coupler-ring spline portion 152 face different outer peripheral surfaces 150 and 170 of the wheel hub 100, it is possible to more easily implement a configuration in which the first interference amount A and the second interference amount B of the present disclosure are differently set (in the unit of several microns) and reinforce the rigidity of a portion (the inner protrusion portion) of the coupler ring 400, which may be affected during the orbital forming process. This makes it possible to further prevent the coupler ring 400 from being deformed.

Further, according to an example embodiment of the present disclosure, the coupler ring 400 may be configured to further include the outer coupler-ring spline portion 460 formed to be engaged with a ring gear (not illustrated) on the outer peripheral surface thereof.

Although not illustrated in FIG. 3, a bumper may be installed on the outer coupler-ring spline portion 460. For example, the gear ring (not illustrated) may have an inner gear-ring spline portion on an inner peripheral surface thereof and may slide along the outer coupler-ring spline portion 460. During the sliding, the gear ring may hit the inner ring 300, thus causing an impact on the inner ring 300. In order to absorb such an impact, the bumper may be installed on at least a part of the outer coupler-ring spline portion 460.

Although the present disclosure has been described with reference to the above example embodiments, it should be noted that various modification, and variations may be devised by those skilled in the art to which the present disclosure pertains without departing from the technical spirit and scope of the present disclosure. Further, the example embodiments described herein are merely examples for explaining the technical sprit of the present disclosure, and the technical sprit of the present disclosure is not limited to the example embodiments. Further, the scope of the present disclosure should be construed within the appended claims, and all technical ideas falling within the equivalent scope thereof should be interpreted as being included in the scope of the disclosure.

### EXPLANATION OF REFERENCE NUMERALS

10: Wheel bearing 100: Wheel hub
120: Small-diameter portion 130: Bent portion
140: Wheel installation flange portion 145: Wheel mounting opening
150: First outer peripheral surface 152: Outer wheel-hub spline portion
153: tooth-shaped portion 154: tooth-shaped groove
160: Second outer peripheral surface 170: Third outer peripheral surface
200: Outer ring 210: Outer raceway surface
220: Vehicle-body installation flange portion 300: Inner ring
310: Inner raceway surface 400: Coupler ring
420: Inner coupler-ring spline portion 422: tooth-shaped portion
424: tooth-shaped groove 440: Inner protrusion portion
442: Inner peripheral surface 460: Outer coupler-ring spline portion
500: Rolling body 600: Wheel mounting bolt
710: Inner bumper spline portion A: First interference magnitude
B: Second interference magnitude C: Third interference magnitude
D1: Outer diameter D3: First inner diameter
D4: Fourth inner diameter T1: Maximum thickness
T2: Minimum thickness

What is claimed is:

1. A vehicular wheel bearing, comprising:
a wheel hub (100) having a bent portion (130) formed by bending an end of a vehicle-body side in a radially outward direction;
at least one inner ring (300) coupled on an outer peripheral surface of the wheel hub (100);
an outer ring (200) provided to be spaced apart by a certain interval from the wheel hub (100) and the at least one inner ring (300) in the radially outward direction;
rolling bodies (500) provided between the wheel hub (100) to which the at least one inner ring (300) is coupled and the outer ring (200); and
a coupler ring (400) disposed between the inner ring (300) and the bent portion (130),
wherein the coupler ring (400) includes an inner coupler-ring spline portion (420), which is coupled to an outer wheel-hub spline portion (152) formed on the outer peripheral surface of the wheel hub (100), and a ring-shaped inner protrusion portion (440) having no spline, which is protruded in a radially inward direction, the inner coupler-ring spline portion (420) and the ring-shaped inner protrusion portion (440) being formed on an inner peripheral surface of the coupler ring (400), and
wherein a first interference magnitude A between the inner protrusion portion (440) and the wheel hub (100) is set to be greater than zero such that the inner protrusion portion (440) and the wheel hub (100) are coupled to each other in a loosely fitting manner.

2. The vehicular wheel bearing of claim 1, wherein the inner coupler-ring spline portion (420) is coupled to the outer wheel-hub spline portion (152) in a press-fitting manner, and
wherein the coupling of the inner coupler-ring spline portion (420) and the outer wheel-hub spline portion (152) in the press-fitting manner is implemented by press-fitting generated between a tooth side surface of the inner coupler-ring spline portion (420) and a tooth side surface of the outer wheel-hub spline portion (152).

3. The vehicular wheel bearing of claim 1, wherein a second interference magnitude B between the inner coupler-ring spline portion (420) and the outer wheel-hub spline portion (152) is set to be greater than zero.

4. The vehicular wheel bearing of claim 1, wherein a third interference magnitude C between the inner coupler-ring spline portion (420) and the outer wheel-hub spline portion (152) is set to be greater than zero.

5. The vehicular wheel bearing of claim 1, wherein a first interference magnitude A between the inner protrusion portion (440) and the wheel hub (100) is in a range of 2 to 7 μm.

6. The vehicular wheel bearing of claim 1, wherein the wheel hub (100) has a first outer peripheral surface (150) on which the outer wheel-hub spline portion (152) is formed, a second outer peripheral surface (160) which extends obliquely from an end of the vehicle-body side to a wheel-side of the first outer peripheral surface (150) in the radially inward direction, and a third outer peripheral surface (170) which extends from an end of the vehicle-body side to the wheel side of the second outer peripheral surface (160),
wherein the first interference magnitude A is formed between the inner protrusion portion (440) and the third outer peripheral surface (170) of the wheel hub (100), and
wherein the second interference magnitude B is formed between the inner coupler-ring spline portion (420) and the first outer peripheral surface (150) of the wheel hub (100).

7. The vehicular wheel bearing of claim 1, wherein a height h3 of the inner protrusion portion (440) is set to be greater than a height h4 of a tooth-shaped portion of the inner coupler-ring spline portion (420).

8. The vehicular wheel bearing of claim 6, wherein an inner peripheral surface (442) of the inner protrusion portion (440) is disposed radially inward of the first outer peripheral surface (150) of the wheel hub (100).

9. The vehicular wheel bearing of claim 1, wherein a maximum thickness T1 of an area in which the inner protrusion portion (440) of the coupler ring (400) is formed falls within a range of 1.2 to 1.8 times a minimum thickness T2 of an area in which the inner coupler-ring spline portion (420) of the coupler ring (400) is formed.

10. The vehicular wheel bearing of claim 1, wherein the inner peripheral surface of the coupler ring (400) is formed by cutting out a portion corresponding to a tooth-shaped groove of the inner coupler-ring spline portion (420) in a ring-shaped structure having a first inner diameter D3 and a second inner diameter D4 smaller than the first inner diameter D3.
